(19) United States
(12) Patent Application Publication
(10) Pub. No.: US 2019/0199900 A1
(43) Pub. Date: Jun. 27, 2019

(54) VARIABLE FIELD OF VIEW TEST PLATFORM

(71) Applicant: Lumileds Holding B.V., Schiphol (NL)

(72) Inventors: Chunxia FENG, Shanghai (CN); Nicola Bettina PFEFFER, Eindhoven (NL); Yu LI, Shanghai (CN)

(73) Assignee: Lumileds Holding B.V., Schiphol (NL)

(21) Appl. No.: 16/225,950

(22) Filed: Dec. 19, 2018

(30) Foreign Application Priority Data
Dec. 22, 2017 (CN) PCT/CN2017/117871

(51) Int. Cl. H04N 5/235; G03B 15/05; G03B 17/26

(52) U.S. Cl. CPC H04N 5/2351; H04N 5/2352; G03B 2215/0503; G03B 17/26; G03B 15/05

(57) ABSTRACT

A system is provided for testing a flash emitter is disclosed. The system may include a mounting panel comprising a plurality of mount points at a center point and at positions that correspond to vertices of at least two different field-of-view configurations. The system may include a device holder separated from the mounting panel by a predetermined distance of a platform. The system may include an adjustment rack coupled to the device holder and the platform, the adjustment rack configured to change a position of the device holder relative to the center point of the mounting panel such that the flash emitter of a device in the device holder is aligned the center point of the mounting panel.

### BACKGROUND

A flash may be a device that may be used in photography for producing a flash of artificial light to help illuminate a scene. Flash devices may be found in various electronic devices, such as smart phones, point-and-shoot cameras, tablets, and others. The performance of flash devices may be normally assessed in accordance with various parameters, such as color of light produced by the flash device, uniformity of the color of light, field of view, and illuminance uniformity. When a flash device is designed, its performance often needs to be evaluated using specialized testing equipment to determine whether if the design is successful.

### SUMMARY

A system for testing a flash emitter may include a mounting panel comprising a plurality of mount points at a center point and at positions that correspond to vertices of at least two different field-of-view configurations. The system may include a device holder separated from the mounting panel by a predetermined distance of a platform. The system may include an adjustment rack coupled to the device holder and the platform. The adjustment rack may be configured to change a position of the device holder relative to the center point of the mounting panel such that the flash emitter of a device in the device holder is aligned the center point of the mounting panel.

### BRIEF DESCRIPTION OF THE DRAWINGS

The drawings described below are for illustration purposes only. The drawings are not intended to limit the scope of the present disclosure. Like reference characters shown in the figures designate the same parts in the various embodiments.

FIG. 1 is a diagram illustrating a process for testing the front and rear flash units of an electronic device, according to aspects of the disclosure;

FIG. 2 is a diagram of an example of a mounting panel, according to aspects of the disclosure;

FIG. 3 is a diagram of another example of a mounting panel, according to aspects of the disclosure;

FIG. 4 is a diagram of yet another example of a mounting panel, according to aspects of the disclosure;

FIG. 5 is a diagram of an example of a system for testing the flash units of an electronic device, according to aspects of the disclosure;

FIG. 6 is a diagram of an example of a process for operating the system of FIG. 5, according to aspects of the disclosure;

FIG. 7 is a flowchart of an example of a sub-process associated with the process of FIG. 6, according to aspects of the disclosure;

FIG. 8 is a diagram illustrating an example of a process for reconfiguring a mounting panel of the system of FIG. 5;

FIG. 9 is a diagram of an example of a processing system for executing at least a portion of the process of FIG. 6, according to aspects of the disclosure; and

FIG. 10 is a flowchart illustrating a method for operating the system of FIG. 5, according to aspects of the disclosure.

### DETAILED DESCRIPTION

A system for testing of a flash emitter device is disclosed. The system may include a mounting panel comprising a plurality of mount points at a center point and at positions that correspond to vertices of at least two different field-of-view configurations. The system may include a device holder separated from the mounting panel by a predetermined distance of a platform. The system may include an adjustment rack coupled to the device holder and the platform, the adjustment rack configured to change a position of the device holder relative to the center point of the mounting panel such that the flash emitter of a device in the device holder is aligned the center point of the mounting panel.

A method of testing a flash emitter is disclosed. The method may include mounting a device in a device holder separated from a mounting panel by a predetermined distance of a platform. The mounting panel may include a plurality of mount points at a center point and at positions that correspond to vertices of at least two different field-of-view configurations. The method may include changing a position of the device holder relative to the center point of the mounting panel such that the flash emitter of a device in the device holder is aligned the center point of the mounting panel. The method may include detecting light emitting from the flash emitter at one or more light detectors in the plurality of mount points.

Another system for testing a flash emitter is disclosed. The system may include a mounting panel comprising a plurality of mount points at a center point and at positions that correspond to vertices of at least two different field-of-view configurations. The system may include a device holder separated from the mounting panel by a predetermined distance of a platform. The system may include an adjustment rack coupled to the device holder and the platform, The adjustment rack may be configured to change a position of the device holder relative to the center point of the mounting panel such that the flash emitter of a device in the device holder is aligned the center point of the mounting panel. The system may include one or more light detectors in the plurality of mount points configured to receive light emitted from the flash emitter.

Electronic devices, such as smart phones or tablets, are often provided with a front flash unit and a rear flash unit. The front flash unit of a device may be disposed on the device's front surface and arranged to work in combination with a front camera. The rear flash unit of the same device may be disposed on the device's rear surface and arranged to work in combination with a rear camera. The front flash unit may have a first field of view (FOV) which may be optimized for “close-range” photography (e.g., self-shots). The rear flash unit may be optimized for “long-range” photography (e.g., shots of groups of people) and it may have a second FOV that may be different from the first FOV.

When flash units are designed, they need to be evaluated to determine whether they meet various performance requirements. Any tests performed on a given flash unit need to take into consideration the FOV of that flash unit in order for them to be accurate. Accordingly, flash unit units having different FOVs may require slightly different test setups for evaluating their respective performances. For example, a flash unit with an FOV having a 4:3 aspect ratio may require a test setup in which light detectors are arranged in accordance with a first configuration. By contrast, a flash unit with an FOV having a 16:9 aspect ratio may require a test setup in which light detectors are arranged in accordance with a second configuration. In some implementations, the FOV aspect ratio of any given flash unit may be the aspect ratio of an illumination pattern/spot (or portion thereof) which may be projected by the given flash unit onto a scene that may be being photographed by a respective camera device that may be associated with the given flash unit.

A system may be used for testing the performance of flash units. The system may be reconfigurable to account for the FOV aspect ratio of different flash units. The system includes a platform (e.g., a table) having a device holder installed on one end, and a mounting panel on the other. The device holder may include any suitable type of device or element that may be capable of holding an electronic device in place, while the device's flash unit may be tested. Inside the device holder, the operator can place an electronic device, such as a smart phone or tablet, and/or any other suitable type of device that includes a flash unit which one might desire to test. The mounting panel includes mount points that are disposed at various locations on the mounting panel, which are arranged to receive light detectors for testing various characteristics of light that may be emitted by a flash unit under test.

According to aspects of the disclosure, the system permits light detectors to be installed and removed at will from different locations on the mounting panel, depending on the aspect ratio of the flash unit that may be tested with the system. For example, when testing a device having respective flash units on the device's front surface and rear surface, an operator may first place the device into the device holder, such that the front flash unit of the device may be facing the mounting panel. Next, the operator may install light detectors in a plurality of first mount points in the mounting panel, which are selected based on the FOV of the front flash unit. After the test of the front flash unit is completed, the operator may turn over the device in the device holder in order to orient the device's rear flash unit towards the mounting panel. Next, the operator may remove the light detectors from the plurality of first mount points and install them in a plurality of second mount points, which are selected based on the FOV aspect ratio of the rear flash unit. After the light detectors are rearranged, the operator may test the rear flash unit in a similar manner as the front flash unit.

Various embodiments are described herein with reference to the figures. It should be noted that the figures are not necessarily drawn to scale and that elements of similar structures or functions are sometimes represented by like reference characters throughout the figures. It should also be noted that the figures are only intended to facilitate the description.

Examples of different light-emitting devices will be described more fully hereinafter with reference to the accompanying drawings. These examples are not mutually exclusive, and features found in one example can be combined with features found in one or more other examples to achieve additional implementations. Accordingly, it will be understood that the examples shown in the accompanying drawings are provided for illustrative purposes only, and they are not intended to limit the disclosure in any way. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element such as a layer, region or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. It will be understood that these terms are intended to encompass different orientations of the element in addition to any orientation depicted in the figures.

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

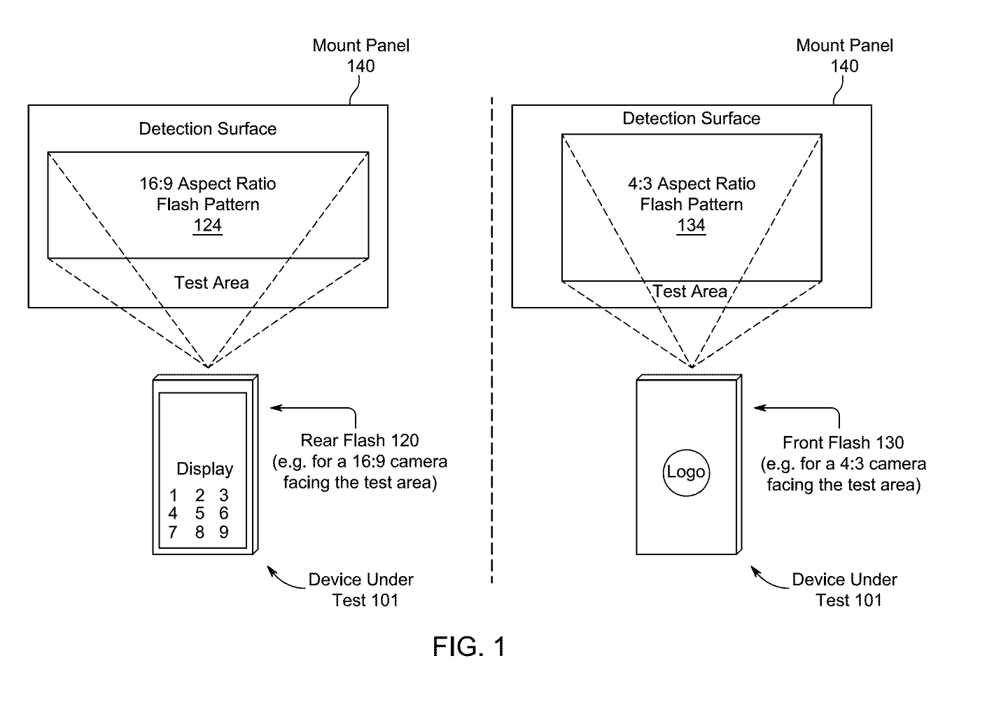

FIG. 1 is a diagram illustrating a process for testing different flash units that are built into the same device. More particularly, FIG. 1 illustrates a process for testing a device 101 (e.g., a smartphone) which includes a rear camera having 16:9 FOV, and a front camera having a 4:3 FOV. The rear camera may be provided with a rear flash unit 120, which may be designed to produce an illumination pattern having a 16:9 aspect ratio. The front camera may be provided with a front flash unit 130, which may be designed to produce an illumination pattern having a 4:3 aspect ratio.

The rear flash unit 120 of the device 101 may be tested by placing the device 101 in front of a mounting panel 140, with the rear flash unit 120 facing the mounting panel 140. The mounting panel has a plurality of mount points formed on its detection surface. Each of the mount points may include a hole, a peg, a bracket, and/or any other suitable element that can be used for coupling a respective light detector (not shown) to the mounting panel. Each light detector may include one or more sensors that are arranged to detect one or more characteristics of light that may be emitted by the rear flash unit. The characteristics may include light color, light intensity, illuminance, and/or any other suitable characteristic of the light emitted by the flash unit (and/or the illumination pattern produced by the flash unit) which in may be usable in some way to evaluate whether the performance of the flash unit satisfies predetermined design specifications. Additionally or alternatively, each of the light detectors may include a communications interface (e.g., a U.S.B. interface or a wireless interface) for transmitting data obtained by the detector to a processing system. The processing system may be configured to receive and store the data that may be obtained from the light detectors.

After the rear flash unit 120 may be arranged to face the mounting panel 140, the rear flash unit 120 may be cycled while it is pointed at the mounting panel. During the cycle, test measurements are made by light detectors that are installed on the mounting panel 140. The test measurements are provided to a processing system that may be coupled to the light detectors. In some implementations, cycling the rear flash unit may include activating the rear flash for a short period of time (e.g., 100-200 ms), as the rear flash would normally be when still images are captured by an associated camera. Additionally or alternatively, in some implementations, cycling the rear flash unit may include activating the rear flash unit for a prolonged period of time (e.g., 1 minute), as the rear flash unit would normally be when video is being captured by an associated camera.

After the tests of the rear flash unit 120 are completed, the device 101 may be turned over to orient its front flash unit 130 towards the mounting panel 140. Next, after the front flash unit 130 may be arranged to face the mounting panel 140, the front flash unit 130 may be cycled while pointed at the mounting panel. During the cycle, test measurements are made by the light detectors that are installed on the mounting panel 140 of the illumination pattern produced by the rear flash unit 120. The test measurements are provided to the processing system that may be coupled to the light detectors.

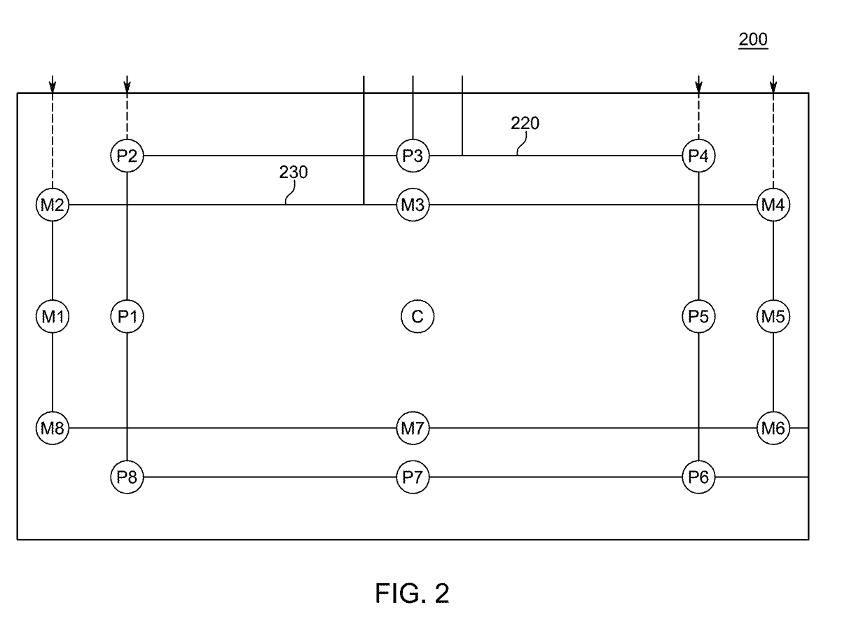

Examples of different mounting panels are now described in further detail with respect to FIGS. 2-4. The mounting panels differ from one another in the manner in which mount points are arranged on their respective detection surfaces. More particularly, FIG. 2 is a diagram illustrating an example of a mounting panel 200, in which mount points are distributed on the edges of a first rectangle 220 and a second rectangle 230. The mounting panel 200 may include a substantially flat rigid member that has enough thickness and/or rigidity to support any light detectors that are installed at mount points that are provided on the mounting panel 200. In the present example, the mounting panel 200 may be provided with a mount point C, a plurality of mount points P1 through P8, and a plurality of mount points M1 through M8. As noted above, each of the mount points may include a hole, a peg, a bracket, and/or any other suitable element that can be used for coupling a light detector (not shown) to the mounting panel 200.

The mount points P1 through P8 are placed on the edges of a rectangle 220, which corresponds to a first FOV configuration, which has a 4:3 aspect ratio. According to the present example, each of the mount points P2, P4, P6, and P8 may be placed on a respective one of the rectangle's vertices. However, alternative implementations are possible in which each of the mount points P2, P4, P6, and P8 may be placed at another location on the rectangle's 220 edges. Furthermore, according to the present example, each of the mount points P1, P3, P5, and P7 may be placed in the middle of a different respective edge of the rectangle 220. However, alternative implementations are possible in which each of the mount points P1, P3, P5, and P7 may be placed at another location on the rectangle's 220 edges.

The mount points M1 through M8 are placed on the edges of a rectangle 230, which corresponds to a second FOV configuration, which has a 16:9 aspect ratio. According to the present example, each of the mount points M2, M4, M6, and M8 may be placed on a respective one of the rectangle's corners. However, alternative implementations are possible in which each of the mount points M2, M4, M6, and M8 may be placed at another location on the rectangle's 230 edges. Furthermore, according to the present example, each of the mount points M1, M3, M5, and M7 may be placed in the middle of a different respective edge of the rectangle 230. However, alternative implementations are possible in which each of the mount points M1, M3, M5, and M7 may be placed at another location on the rectangle's 230 edges.

The mount point C may be placed at the center of rectangles 220 and 230. In other words, the mount point C may be placed at the intersection of the diagonals of the rectangle 220, as well as the intersection of the diagonals of the rectangle 230.

As noted above, the rectangle 220 corresponds to a 4:3 FOV. Accordingly, in some implementations, the ratio of any two adjacent edges of the rectangle 150 may be 4:3. Furthermore, as noted above, the rectangle 230 may correspond to a 16:9 FOV. Accordingly, in some implementations, the ratio of any two adjacent edges of the rectangle 220 may be 16:9. The foregoing aspect ratios discussed (namely 16 by 9 and 4 by 3) are provided only as examples. The present disclosure is not limited to any specific type of aspect ratio.

Generally, when a scene is photographed using a camera, images are deemed aesthetically pleasing if the scene is uniformly illuminated across the entire FOV of the camera. The uniformity of illumination produced by a flash unit may be measured in accordance with a number of metrics, such as uniformity of light intensity, illuminance uniformity, color uniformity, etc. The uniformity may be desired to occur throughout the entire FOV of the flash unit—both in the vertical dimension as well as in the horizontal dimension. Testing of such uniformity may be often performed so that the imaging devices capture scenes that are uniformly illuminated throughout the intended field of view.

To ensure the accuracy of measurements throughout the intended field of view, the illuminance and color temperature values taken from at least nine points should be measured during the same flash unit cycle. Moreover, there are many factors that can affect the accuracy and reliability of measurement data. Examples of such factors include, for instance, the distance between the flash unit and the center of mounting panel, whether the axis of flash unit may be perpendicular to the target surface, and whether the detectors are properly positioned with respect to the field of view of interest, etc.

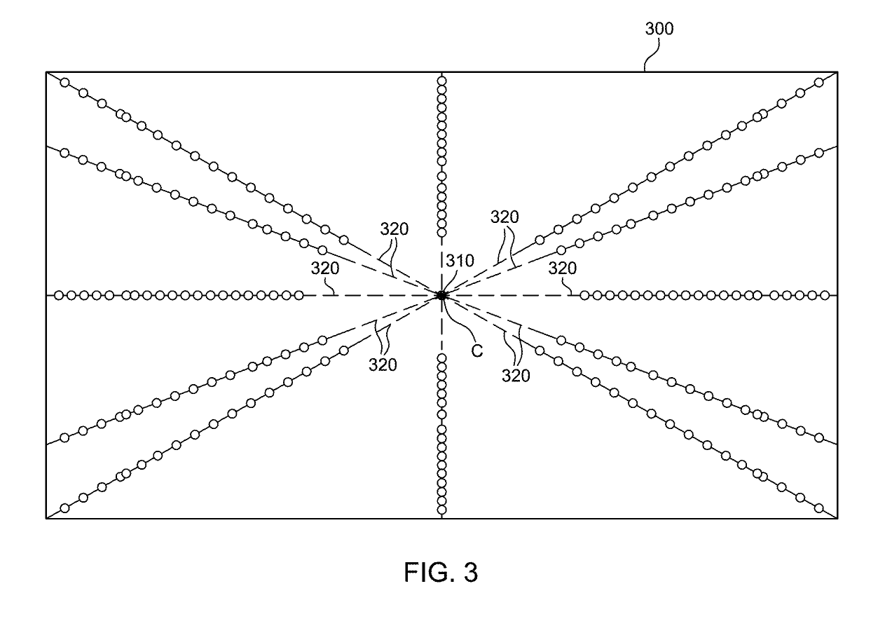

FIG. 3 is a diagram illustrating an example of a mounting panel 300, in which mount points are placed at the center 310 of the mounting panel 300, as well as along rays 320 originating from the center 310 and extending towards the edges of the mounting panel 300. The mount points in FIG. 3 are depicted as circles superimposed on the rays 320. Along each of the rays 320, the mount points may be spaced 1 mm apart from one another, and or any other suitable distance. Although in the present example, only twelve rays 320 are present in the mounting panel 300, alternative implementations are possible. For example, the rays might be defined at 1 degree increments around the center C.

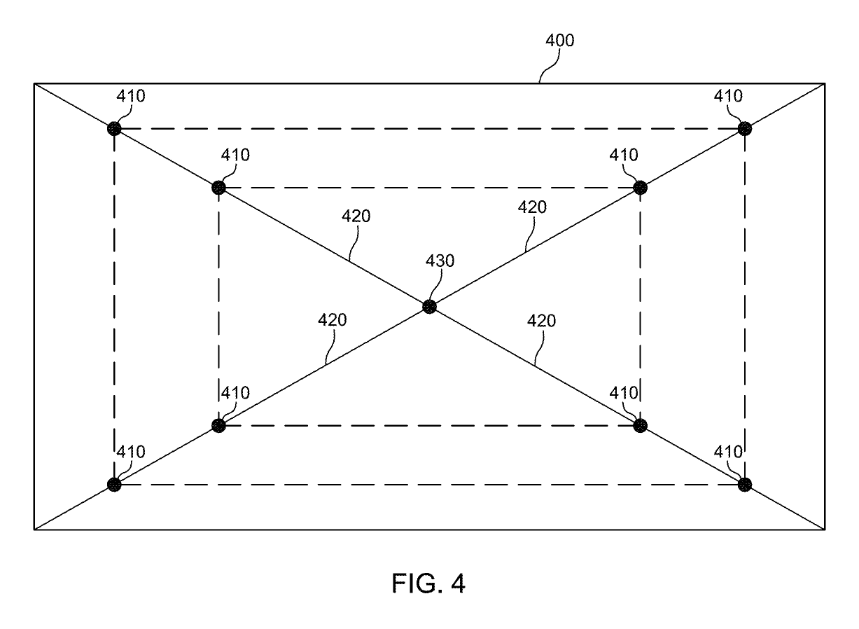

FIG. 4 is a diagram of an example of a mounting panel 400, according to aspects of the disclosure. In the present example, mount points 410 are disposed on rays 420 which originate from at a central point 430 of the mounting panel. In the present example, the mount points 410 define a plurality of nested rectangles having the same aspect ratio, which correspond to a give FOV configuration (e.g., one of a 4:3 FOV configuration and a 16:9 FOV configuration). As noted above, in some implementations, a minimum of nine light detectors may be needed to test the performance of a flash unit. Accordingly, when the mounting panel 400 may be used to test a given flash unit, a light detector may be placed at the mount points 410 on each of the edges of the nested rectangles. Although not shown in FIG. 4, the mounting panel 400 may include additional mount points which are disposed on the edges of another set of nested rectangles. In such instances, the other set of nested rectangles may correspond to another FOV configuration (e.g., the other of a 4:3 FOV configuration and a 16:9 FOV configuration).

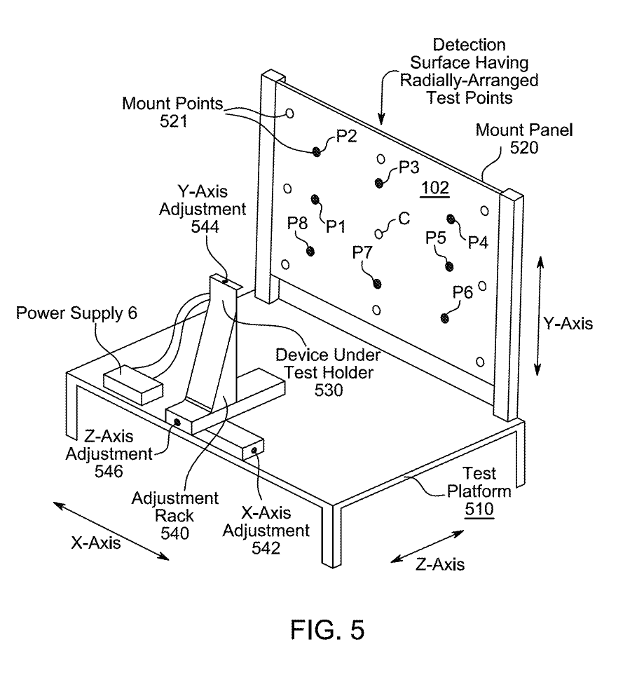

FIG. 5 is a diagram of a system 500 for testing a flash unit, according to aspects of the disclosure. The system 500 includes a platform 510, a mounting panel 520 coupled to a first end of the platform 510, and a device holder 530 coupled to a second end of the platform that may be opposite the first end via an adjustment rack 240. In addition, the system 500 includes a power supply 550 for powering the device under test.

The platform 510 may include a table, and/or any other similar platform. The mounting panel 520 may include a substantially flat rigid panel that possesses enough thickness and/or rigidity to support the positioning mount points on the surface of the mounting panel 520. In the present example, the mounting panel 520 features a radial configuration of mount points. More particularly, the mounting panel 520 includes a plurality of mount points 221 which are disposed along rays which radiate from the mount point C.

The device holder 530 may include may include any suitable type of device for holding a device whose flash unit may be being tested (e.g., a smart phone) in a fixed position relative to the mounting panel 520. The adjustment rack 540 may include any suitable type of device that may be arranged to change the position of the device holder along at least one of an x-axis, y-axis, and a z-axis. In some implementations, the adjustment rack may include an x-axis adjustment 542, a y-axis adjustment 544, and a z-axis adjustment 546. In some implementations, the x-axis adjustment 542 may include a rail that may be configured to slide back and forth along the y-axis when a knob on the rail may be turned. Additionally or alternatively, in some implementations, the y-axis adjustment 544 may include a rail that may be configured to slide back and forth along the y-axis when a knob on the rail may be turned. Additionally or alternatively, in some implementations, the y-axis adjustment 544 may include a rail that may be configured to slide back and forth along the y-axis when a knob on the rail may be turned.

In the present example, the adjustment rack 540 allows the device holder 530 (or a device that may be placed in the device holder) to be moved linearly with respect to the mounting panel 520. However, in some implementations, the adjustment rack 540 may also permit the device holder 530 (or a device placed in the device holder 530) to be rotated relative to the mounting panel 520. For example, the adjustment rack 540 may allow changing at least one of pitch, yaw, and raw of the device holder 530 (or a device that may be placed in the device holder 530), relative to the mounting panel 520. In some implementations, a device whose flash unit may be being tested (e.g., a smart phone) may need to be oriented with respect to the detection surface of the mounting panel 520, such that the area illuminated by the flash unit may be large enough to ensure the measurement of a 90° field of view (e.g., as observed from the position of the device under test).

According to aspects of the disclosure, the device holder 530 may be approximately aligned with the central mount point C on the mounting panel 520. As used throughout the disclosure, the phrase “approximately aligned” shall refer to the property of the device holder 530 and/or the adjustment rack 540, wherein the device holder 530 and/or the adjustment rack 540 are placed in a position relative to the central mount point C, which permits the flash unit of any device that may be placed in the device holder to be substantially aligned with the central point C by using the adjustment rack 540 to adjust the position of the device and/or device holder 530 along at least one of the x-axis, the y-axis, and the z-axis. As used throughout the disclosure, the phrase “substantially aligned” shall refer to an alignment between the device and the central mount point C which permits testing how well the flash unit of the device that may be being tested collimates light.

In some implementations, the system, 500 may include a plurality of light detectors (not shown) which are configured to be mounted at the mount points 522. Additionally or alternatively, in some implementations, the system may include fewer light detectors than there are mount points on the mounting panel 520. In such instances, the light detectors may be installed at different mount points depending on the FOV aspect ratio that needs to be tested. For instance, if a flash unit has a first FOV aspect ratio (e.g., a 4:3 aspect ratio), the light detectors may be installed in a first set of locations. Afterwards, if the performance of another flash unit needs to be tested, which has another FOV aspect ratio (e.g., a 16:9 aspect ratio), the light detectors may be removed (e.g., by an operator) from the first set of mount points and installed at a second set of mount points. The first set of mount points and the second set of mount points may be different from one another. Moreover, each of the first set and the second set of mount points may be a proper subset of all mount points that are available on the mounting panel 520.

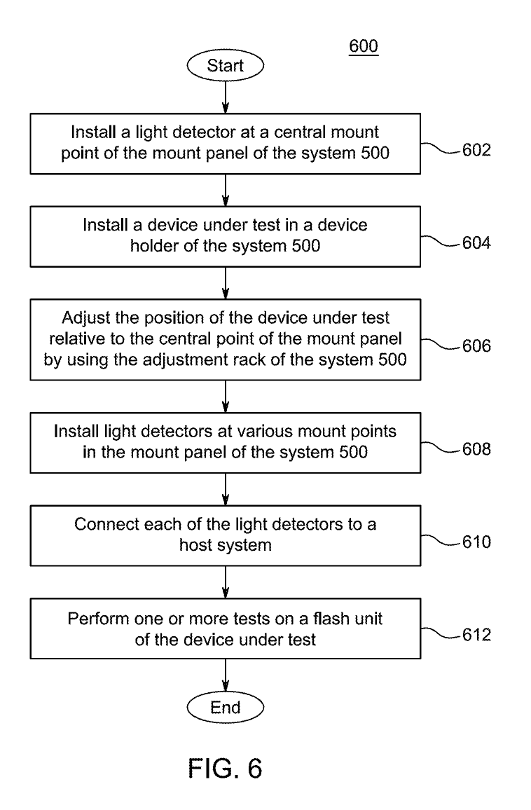

FIG. 6 is a flowchart of an example of a process 600 for using the system 500 to test the flash unit of an electronic device (hereinafter “device under test”), according to aspects of the disclosure. At step 602, a light detector may be installed at the central mount point C of the mounting panel 520. At step 604 a device may be installed in the device holder 530, and the position of the device and/or device holder 530 may be adjusted by using the alignment rack 540, so that the device (or a flash unit of the device) may be substantially aligned with the light detector installed in the central mount point C. As noted above, aligning the device (or the device's flash unit) may be necessary for measuring how well the flash unit of the device collimates light. At step 606, the distance between the device under test and the mounting panel 520 may be adjusted by using the adjustment rack 240.

At step 608, a plurality (e.g., eight) light detectors are installed at mount points on the mounting panel 520, which correspond to the FOV of the device's flash unit, and/or the distance between the device under test. In some implementations, the light detector may be arranged in a rectangular configuration, wherein each of the light detector may be placed on an edge of a rectangle corresponding to the FOV of the device. In some implementations, the edges of the rectangle may lie on the fringes of the illumination pattern produced by the flash unit of the device under test when the flash unit may be activated while being held in the device holder 530.

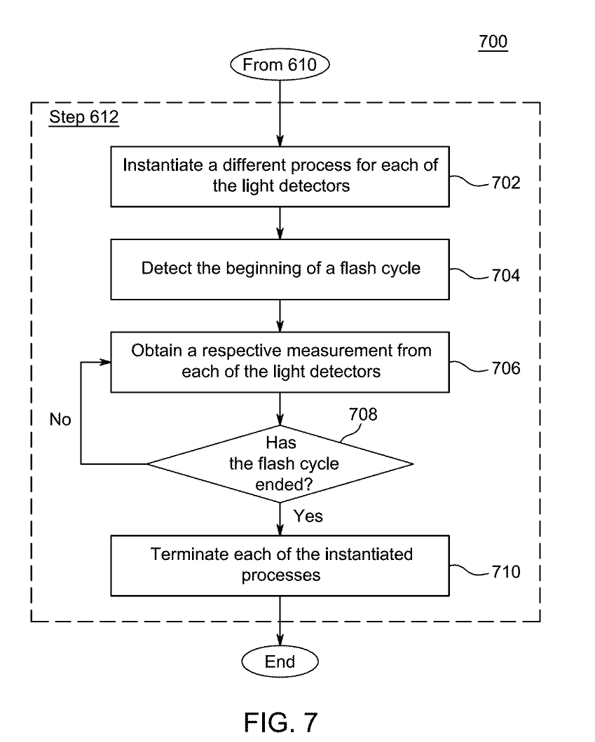

At step 610, the all light detectors that have been mounted onto the mounting panel 520 are connected to a processing system. The light detector may be connected using a universal serial bus (USB) interface, and/or any other suitable computer-to-device connection interface. In some implementations, each of the light detectors may be connected to the processing system over a different channel (e.g., a logical channel, a virtual channel, and/or a physical channel). At step 612, one or more tests are performed on the flash unit of the device under test. For example, the tests may include one or more illumination tests, on or more color variance tests, etc. The tests may be performed by the processing system, as discussed further below with respect to FIG. 7.

FIG. 7 is a flowchart of a sub-process 700 for performing step 612 of process 600 as described above. At step 702 a different process may be instantiated (e.g., forked from a parent process) for each of the light detectors that are mounted on the mounting panel 520. As can readily be appreciated, instantiating a separate process for each of the light detectors may permit the processing system to operate the light detectors in parallel. This in turn may permit the processing system to concurrently receive data from all light detectors at once and/or to concurrently sample the light detectors.

At step 704, the beginning of a flash cycle may be detected by the processing system. In some implementations, detecting the beginning of the flash cycle may include detecting that the flash unit of the device under test has begun to emit light.

At step 706 a respective measurement (e.g., a sample) may be obtained from at least some (or all) of the light detectors. For example, in some implementations, a measurement may be obtained from each of the light detectors that are mounted on the mounting panel 520. In some implementations, the measurement may indicate at least one of luminance, a color of the light output by the flash unit, intensity of the light emitted by the flash unit, and/or any other suitable characteristic of the light emitted by the flash unit (and/or the illumination pattern produced by the flash unit) which in may be usable in some way to evaluate whether the performance of the flash unit satisfies predetermined design specifications. In some implementations, the obtained measurements may be stored in a memory of the processing system, such as a hard drive and/or any other suitable type of storage device.

At step 708, a determination may be made of whether the flash unit is still in cycle. According to aspects of the disclosure, the determination may include detecting whether the flash unit is continuing to emit light (e.g., without interruption, since the beginning of the cycle.). If the flash unit is still in cycle, the process returns to step 708 and the light detectors are used to take additional measurements. In some implementations, the duration of the cycle of the flash unit may be in the order of a few hundred milliseconds, which may permit step 706 to be executed several times before the cycle is over. Otherwise, if the flash unit may be no longer in cycle, the process proceeds to step 710.

At step 710, the processes that are instantiated at step 704, are terminated (e.g., joined with the parent process).

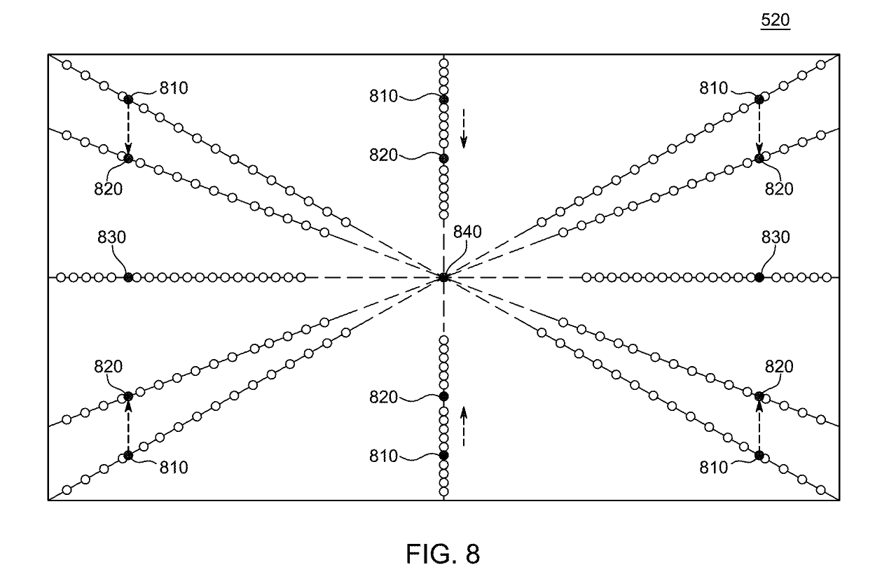

According to aspects of the disclosure, the process 600 may be used to test the front flash unit of an electronic device which includes both a front flash unit and a rear flash unit. After the testing of the front flash unit is completed, the mounting panel 520 of the system 500 may be reconfigured, and the process 600 may be executed again to test the rear flash unit of the device. As can be readily appreciated, before the process 600 may be executed again, the device may need to be turned in the device holder 530 in order to orient the rear flash unit of the device towards the mounting panel 520. The manner in which the mounting panel 520 may be reconfigured is discussed further below with respect to FIG. 8.

FIG. 8 is a diagram of illustrating a process for reconfiguring the mounting panel 520 of the system 500 in order to test another flash unit, such as the rear flash unit discussed above. As illustrated, the mounting panel 520 may be configured in the same or similar manner as the mounting panel 300. When the process 600 is executed for a first time, a respective light detector may be placed in a central mount point 840, mount points 810, and mount points 830. After the process 600 is executed for the first time, all light detectors that are installed at the mount point 810 can be relocated to the mount points 820, after which the process 600 can be executed again. As illustrated, in the present example, the mount points 810 are arranged on the vertices of a first rectangle which may be associated with a first FOV configuration, and the mount points 820 are arranged on the vertices of a second rectangle which may be associated with a second FOV configuration that may be different from the first FOV configuration. As noted above, the first rectangle may correspond to the FOV configuration of a device's front flash unit, and the second rectangle may correspond to the FOV configuration of a rear flash unit of the same device.

In some implementations, the mount point 840 may be situated in the center of both rectangles. Furthermore, the distance between a particular mount point and the center hole should be labelled with labeling information that may be visibly-associated with a respective positioning hole. Such labeling information can be used in conjunction with the processing system to define and calibrate the test configuration.

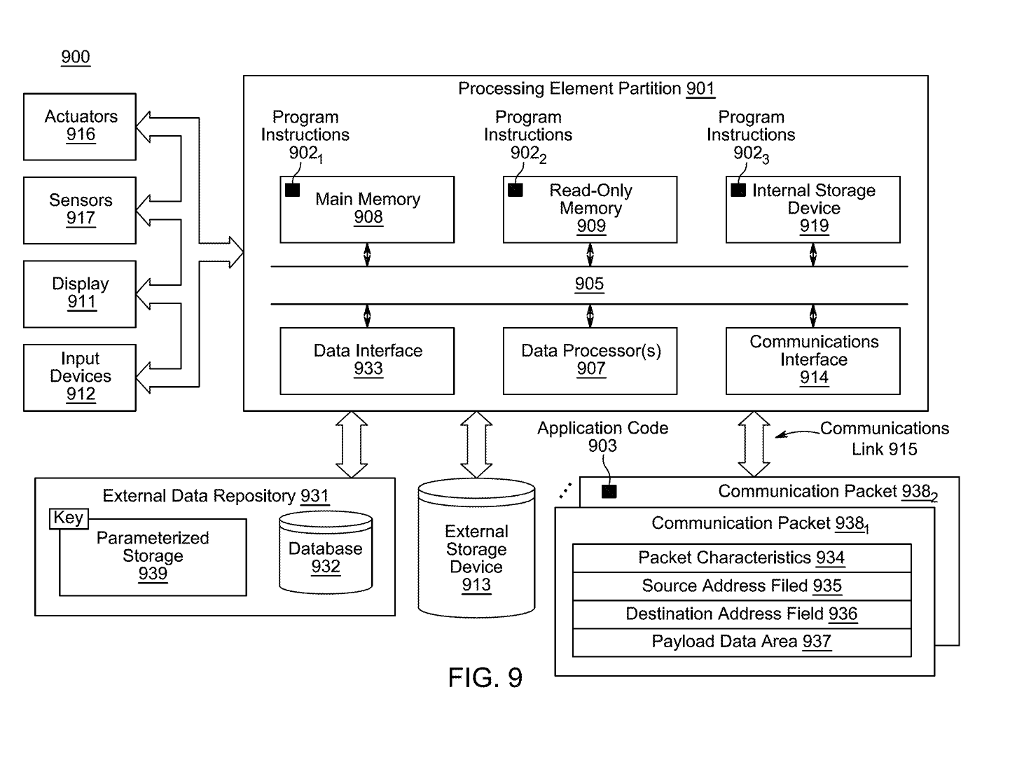

FIG. 9 is a block diagram of an example of a processing system 900, which may be configured to execute at least the sub-process 700 which is discussed with respect to FIG. 7, according to aspects of the disclosure. As illustrated, the system 900 includes communication links (e.g., busses) or other communication mechanisms for communicating information. As shown, one such communication link 905 interconnects subsystems and devices such as a CPU, or a multi-core CPU (e.g., data processor 907), a system memory (e.g., main memory 908, or an area of random access memory (RAM)), a non-volatile storage device or non-volatile storage area (e.g., read-only memory 909), an internal storage device 919 or external storage device 913 (e.g., magnetic or optical), a data interface 933, a communications interface 914 (e.g., PHY, MAC, Ethernet interface, modem, etc.). The aforementioned components are shown within processing element partition 901, however other partitions are possible. The shown system 900 further comprises a display 911 (e.g., CRT or LCD and/or other output devices), various input devices 912 (e.g., keyboard, cursor control), I/O to and from actuators 916 (e.g., electro-mechanical actuators pertaining to automated fabrication tools or robots), I/O to and from sensors 917, and an external data repository 931.

The system 900 may perform specific operations by data processor 907 executing one or more sequences of one or more program code instructions contained in a memory. Such instructions (e.g., program instructions 902₁, program instructions 902₂, program instructions 902₃, etc.) can be contained in or can be read into a storage location or memory from any computer readable/usable medium such as a static storage device or a disk drive. The sequences can be organized to be accessed by one or more processing entities configured to execute a single process or configured to execute multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

The system 900 may perform specific networking operations using one or more instances of communications interface 914. Instances of the communications interface 914 may comprise one or more networking ports that are configurable (e.g., pertaining to speed, protocol, physical layer characteristics, media access characteristics, etc.) and any particular instance of the communications interface 914 or port thereto can be configured differently from any other particular instance. Portions of a communication protocol can be carried out in whole or in part by any instance of the communications interface 914, and data (e.g., packets, data structures, bit fields, etc.) can be positioned in storage locations within communications interface 914, or within system memory, and such data can be accessed (e.g., using random access addressing, or using direct memory access DMA, etc.) by devices such as data processor 907.

The communications link 915 can be configured to transmit (e.g., send, receive, signal, etc.) any types of communications packets (e.g., communications packet 938₁, communications packet 938_{N}) comprising any organization of data items. The data items can comprise a payload data area 937, a destination address 936 (e.g., a destination IP address), a source address 935 (e.g., a source IP address), and can include various encodings or formatting of bit fields to populate the shown packet characteristics 934. In some cases the packet characteristics include a version identifier, a packet or payload length, a traffic class, a flow label, etc. In some cases the payload data area 937 comprises a data structure that may be encoded and/or formatted to fit into byte or word boundaries of the packet.

Hard-wired circuitry may be used in place of or in combination with software instructions to implement aspects of the disclosure. Thus, the description is not limited to any specific combination of hardware circuitry and/or software. The term “logic” shall mean any combination of software or hardware that may be used to implement all or part of the disclosure.

The term “computer readable medium” or “computer usable medium” as used herein refers to any medium that participates in providing instructions to data processor 907 for execution. Such a medium may take many forms including, but not limited to, non-volatile media and volatile media. Non-volatile media includes, for example, optical or magnetic disks such as disk drives or tape drives. Volatile media includes dynamic memory such as a random access memory.

Common forms of computer readable media includes, for example, floppy disk, flexible disk, hard disk, magnetic tape, or any other magnetic medium; CD-ROM or any other optical medium; punch cards, paper tape, or any other physical medium with patterns of holes; RAM, PROM, EPROM, FLASH-EPROM, or any other memory chip or cartridge, or any other non-transitory computer readable medium. Such data can be stored, for example, in any form of external data repository 931, which in turn can be formatted into any one or more storage areas, and which can comprise parameterized storage 939 accessible by a key (e.g., filename, table name, block address, offset address, etc.).

Execution of the sequences of may be performed by a single instance of the system 900. Two or more instances of the processing system 900 coupled by a communications link 915 (e.g., LAN, PTSN, or wireless network) may perform the sequence of instructions required by the above description using two or more instances of components of system 900.

The system 900 may transmit and receive messages such as data and/or instructions organized into a data structure (e.g., communications packets). The data structure can include program instructions (e.g., application code 903), communicated through communications link 915 and communications interface 914. Received program code may be executed by data processor 907 as it is received and/or stored in the shown storage device or in or upon any other non-volatile storage for later execution. In some implementations, the system 900 may communicate through a data interface 933 to a database 932 on an external data repository 931. Data items in a database can be accessed using a primary key (e.g., a relational database primary key).

The processing element partition 901 may be merely one sample partition. Other partitions can include multiple data processors, and/or multiple communications interfaces, and/or multiple storage devices, etc. within a partition. For example, a partition can bound a multi-core processor (e.g., possibly including embedded or co-located memory), or a partition can bound a computing cluster having plurality of computing elements, any of which computing elements are connected directly or indirectly to a communications link. A first partition can be configured to communicate to a second partition. A particular first partition and particular second partition can be congruent (e.g., in a processing element array) or can be different (e.g., comprising disjoint sets of components).

A module as used herein can be implemented using any mix of any portions of the system memory and any extent of hard-wired circuitry including hard-wired circuitry embodied as a data processor 907. One or more special-purpose hardware components (e.g., power control, logic, sensors, transducers, etc.) may be used. A module may include instructions that are stored in a memory for execution so as to implement algorithms that facilitate operational and/or performance characteristics pertaining to the herein-disclosed test system. A module may include one or more state machines and/or combinational logic used to implement or facilitate the operational and/or performance characteristics of the herein-disclosed test system.

Various implementations of the database 932 comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of this disclosure). Such files or records can be brought into and/or stored in volatile or non-volatile memory.

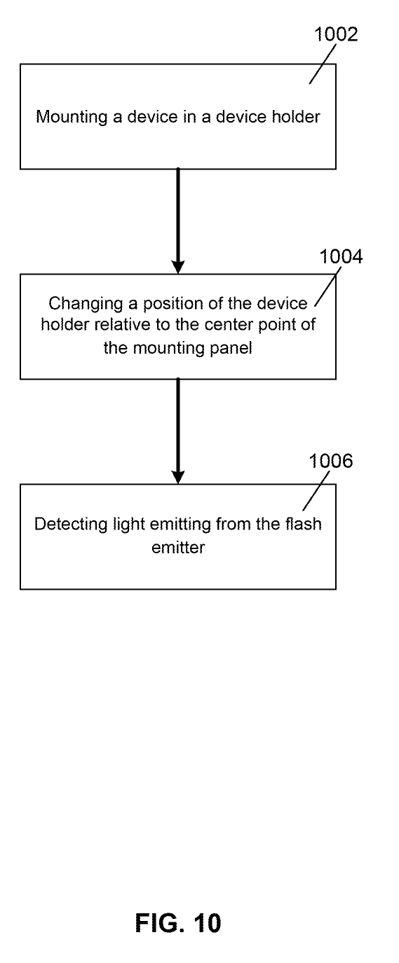

Referring now to FIG. 10, a flowchart illustrating a method of using the system 500 to test the flash unit of an electronic device is shown.

In step 1002, a device may be mounted in a device holder separated from a mounting panel by a predetermined distance of a platform. The mounting panel may include a plurality of mount points at a center point and at positions that correspond to vertices of at least two different field-of-view configurations.

In step 1004, a position of the device holder may be changed relative to the center point of the mounting panel such that the flash emitter of a device in the device holder may be aligned the center point of the mounting panel.

In step 1006, light emitted from the flash emitter may be detected at one or more light detectors in the plurality of mount points.

The figures above are provided as an example only. At least some of the steps discussed with respect to these figures can be arranged in different order, combined, and/or altogether omitted. In this regard, it will be understood that the provision of the examples described herein, as well as clauses phrased as “such as,” “e.g.”, “including”, “in some aspects,” “in some implementations,” and the like should not be interpreted as limiting the disclosed subject matter to the specific examples.

Having described the invention in detail, those skilled in the art will appreciate that, given the present disclosure, modifications may be made to the invention without departing from the spirit of the inventive concepts described herein. Therefore, it is not intended that the scope of the invention be limited to the specific embodiments illustrated and described.

What is claimed is:

1. A system for testing a flash emitter, the system comprising:
a mounting panel comprising a plurality of mount points at a center point and at positions that correspond to vertices of at least two different field-of-view configurations;
a device holder separated from the mounting panel by a predetermined distance of a platform; and
an adjustment rack coupled to the device holder and the platform, the adjustment rack configured to change a position of the device holder relative to the center point of the mounting panel such that the flash emitter of a device in the device holder is aligned the center point of the mounting panel.

2. The system of claim 1, wherein the plurality of mount points comprise one or more of a first rectangle corresponding to a first field-of-view configuration and a second rectangle corresponding to a second field-of-view configuration.

3. The system of claim 2, wherein the first rectangle corresponds to a 4:3 field-of-view configuration and the second rectangle corresponds to a 16:9 field-of-view configuration.

4. The system of claim 1, wherein the mounting panel consists of mount points on the center point, one or more edges of a first rectangle corresponding to a first field-of-view configuration, and one or more edges of a second rectangle corresponding to a second field-of-view configuration.

5. The system of claim 1, further comprising a power supply on the platform, the power supply configured to provide power to the device.

6. The system of claim 1, wherein the adjustment rack includes a plurality of adjustment members for adjusting the position of the device holder relative to the center point of the mounting panel.

7. The system of claim 1, wherein the adjustment rack comprises one or more of a z-axis adjustment member, an x-axis adjustment member, and a y-axis adjustment member.

8. The system of claim 1, wherein the plurality of mount points are distributed radially from the center point.

9. The system of claim 1, further comprising one or more light detectors in the plurality of mount points.

10. A method for testing a flash emitter, the method comprising:
mounting a device in a device holder separated from a mounting panel by a predetermined distance of a platform, the mounting panel comprising a plurality of mount points at a center point and at positions that correspond to vertices of at least two different field-of-view configurations;
changing a position of the device holder relative to the center point of the mounting panel such that the flash emitter of a device in the device holder is aligned the center point of the mounting panel; and
detecting light emitted from the flash emitter at one or more light detectors in the plurality of mount points.

11. The method of claim 10, wherein the plurality of mount points comprise one or more of a first rectangle corresponding to a first field-of-view configuration and a second rectangle corresponding to a second field-of-view configuration.

12. The method of claim 11, wherein the first rectangle corresponds to a 4:3 field-of-view configuration and the second rectangle corresponds to a 16:9 field-of-view configuration.

13. The method of claim 10, wherein the mounting panel consists of mount points on the center point, one or more edges of a first rectangle corresponding to a first field-of-view configuration, and one or more edges of a second rectangle corresponding to a second field-of-view configuration.

14. The method of claim 10, further comprising:
providing power to the device using a power supply on the platform.

15. The method of claim 10, wherein the adjustment rack includes a plurality of adjustment members for adjusting the position of the device holder relative to the center point of the mounting panel.

16. The method of claim 10, wherein the adjustment rack comprises one or more of a z-axis adjustment member, an x-axis adjustment member, and a y-axis adjustment member.

17. The method of claim 10, wherein the plurality of mount points are distributed radially from the center point.

18. A system for testing a flash emitter, the system comprising:
a mounting panel comprising a plurality of mount points at a center point and at positions that correspond to vertices of at least two different field-of-view configurations;
a device holder separated from the mounting panel by a predetermined distance of a platform;
an adjustment rack coupled to the device holder and the platform, the adjustment rack configured to change a position of the device holder relative to the center point of the mounting panel such that the flash emitter of a device in the device holder is aligned the center point of the mounting panel; and
one or more light detectors in the plurality of mount points configured to receive a light emitted from the flash emitter.

19. The system of claim 18, wherein the plurality of mount points comprise one or more of a first rectangle corresponding to a first field-of-view configuration and a second rectangle corresponding to a second field-of-view configuration.

20. The system of claim 18, wherein a number of the one or more light detectors is less than a number of the plurality of mount points.
